(19) United States
(12) Patent Application Publication
(10) Pub. No.: US 2026/0032014 A1
(43) Pub. Date: Jan. 29, 2026

(54) BOOSTING NETWORK EFFICIENCY

(71) Applicant: MaxLinear, Inc., Carlsbad, CA (US)

(72) Inventor: Saju Palayur, Poway, CA (US)

(73) Assignee: MaxLinear, Inc., Carlsbad, CA (US)

(21) Appl. No.: 19/280,030

(22) Filed: Jul. 24, 2025

Related U.S. Application Data
(60) Provisional application No. 63/675,156, filed on Jul. 24, 2024.

(51) Int. Cl. H04L 12/28; H04L 12/66; H04L 41/5009

(52) U.S. Cl. CPC H04L 12/2801; H04L 12/66; H04L 41/5009

(57) ABSTRACT

A gateway may include a processing device. The processing device may: receive, at the gateway, data using a data over cable service interface specification (DOCSIS) protocol in which the data is received using a first quality of service (QoS) operation; identify, at the gateway, the first QoS operation for the DOCSIS protocol; determine, at the gateway, a second QoS operation for a wireless local area network (WLAN) protocol; and send, from the gateway to a station (STA), the data using the WLAN protocol in which the data is sent using the second QoS operation.

### RELATED APPLICATION

This application claims the benefit of U.S. Provisional Application No. 63/675,156, filed Jul. 24, 2024, the disclosure of which is incorporated herein by reference in its entirety.

The examples discussed in the present disclosure are related to enhancements to network efficiency and Quality of Service (QoS).

### BACKGROUND

Unless otherwise indicated herein, the materials described herein are not prior art to the claims in the present application and are not admitted to be prior art by inclusion in this section.

As internet services are used for streaming, gaming, and remote work, ensuring a high-quality user experience is useful. Quality of Service (QoS) may be used to prioritize various types of network traffic to optimize performance. Data Over Cable Service Interface Specification (DOCSIS) and Wi-Fi® use different QoS mechanisms.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a gateway may include a processing device. The processing device may receive, at the gateway, data using a data over cable service interface specification (DOCSIS) protocol in which the data is received using a first quality of service (QoS) operation. The processing device may identify, at the gateway, the first QoS operation for the DOCSIS protocol. The processing device may determine, at the gateway, a second QoS operation for a wireless local area network (WLAN) protocol. The processing device may send, from the gateway to a station (STA), the data using the WLAN protocol in which the data is sent using the second QoS operation.

In some examples, the processing device may receive, at the gateway, data using a Third Generation Partnership Project (3GPP) fifth generation (5G) protocol in which the data is received using a first QoS operation. The processing device may identify, at the gateway, the first QoS operation for the 3GPP 5G protocol. The processing device may determine, at the gateway, a second QoS operation for a WLAN protocol. The processing device may send, from the gateway to a STA, the data using the WLAN protocol in which the data is sent using the second QoS operation.

In some examples, the processing device may receive, at the gateway, data using a passive optical network (PON) protocol in which the data is received using a first QoS operation. The processing device may identify, at the gateway, the first QoS operation for the PON protocol. The processing device may determine, at the gateway, a second QoS operation for a WLAN protocol. The processing device may send, from the gateway to a STA, the data using the WLAN protocol in which the data is sent using the second QoS operation.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example network architecture.

FIG. 2 illustrates an example data over cable service interface specification (DOCSIS) data flow.

FIG. 3 illustrates an example wireless local area network (WLAN) data flow.

FIG. 4 illustrates an example of DOCSIS and WLAN synchronization.

FIG. 5 illustrates an example of congestion detection.

FIG. 6 illustrates an example of Third Generation Partnership Project (3GPP) fifth generation (5G) and WLAN synchronization.

FIG. 7 illustrates an example of passive optical network (PON) and WLAN synchronization.

FIG. 8 illustrates a process flow of boosting network efficiency.

FIG. 9 illustrates a process flow of boosting network efficiency.

FIG. 10 illustrates a process flow of boosting network efficiency.

FIG. 11 illustrates an example communication system.

FIG. 12 illustrates a diagrammatic representation of a machine in the example form of a computing device within which a set of instructions, for causing the machine to perform any one or more of the methods discussed herein, may be executed.

### DESCRIPTION

Internet services may be useful for streaming, gaming, and remote work. Quality of Service (QoS) may be used to maintain a good user experience by prioritizing various types of network traffic to optimize performance. QoS operations may be different in data over cable service interface specification (DOCSIS), wireless local area network (WLAN), third generation partnership project (3GPP) 5G, and passive optical networks (PONs).

QoS may be used so that users may receive a seamless experience. The QoS mechanisms employed by DOCSIS, WLAN, 3GPP 5G, and PONs may different, but the present disclosure provides techniques for how DOCSIS, WLAN, 3GPP 5G, and PON QoS operations may collaborate to create synergies, thereby enhancing network efficiency and user experience.

To understand the importance of QoS, different performance metrics that influence network efficiency and user experience may be examined. These metrics include throughput, latency, and jitter.

Throughput may measure the amount of data transferred over a network in a given period, usually in bits per second (bps). Higher throughput may indicate a network's capacity to handle more data, which may be used for bandwidth-intensive applications such as video streaming and large file transfers.

Latency may refer to the delay in network communication, indicating the time taken for data to transfer across the network. Low latency may be used for applications that use real-time data transmission, such as online gaming, video conferencing, and Voice over Internet Protocol (VOIP). High latency may lead to noticeable delays and a poor user experience.

Jitter may be the variability in packet arrival time. Inconsistent packet delivery may affect the quality of audio and video data, leading to choppy or distorted playback. Minimizing jitter may maintain a smooth and reliable user experience for real-time applications.

Examples of the present disclosure will be explained with reference to the accompanying drawings.

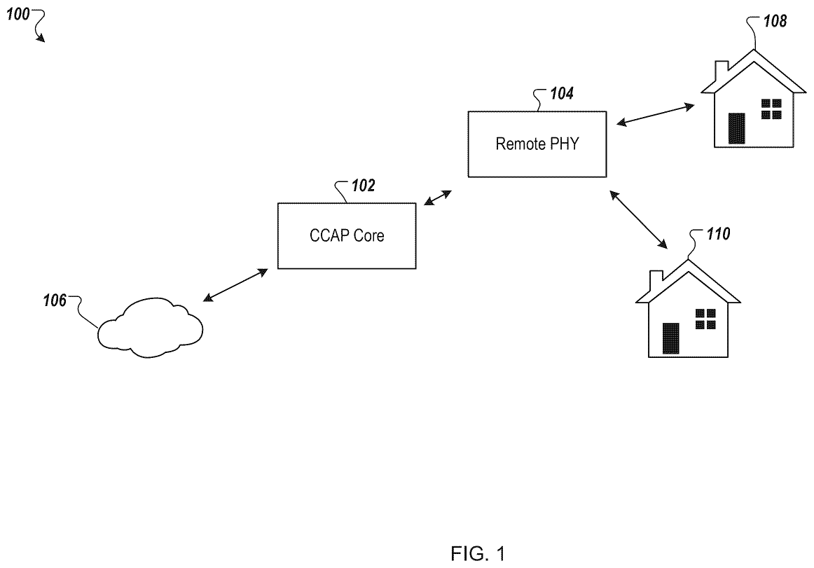

As illustrated in FIG. 1, a network architecture 100 may include one or more of a converged cable access platform (CCAP) core 102, a remote physical layer (PHY) device (RPD) 104, a network 106, a first end user 108, or a second end user 110.

### DOCSIS

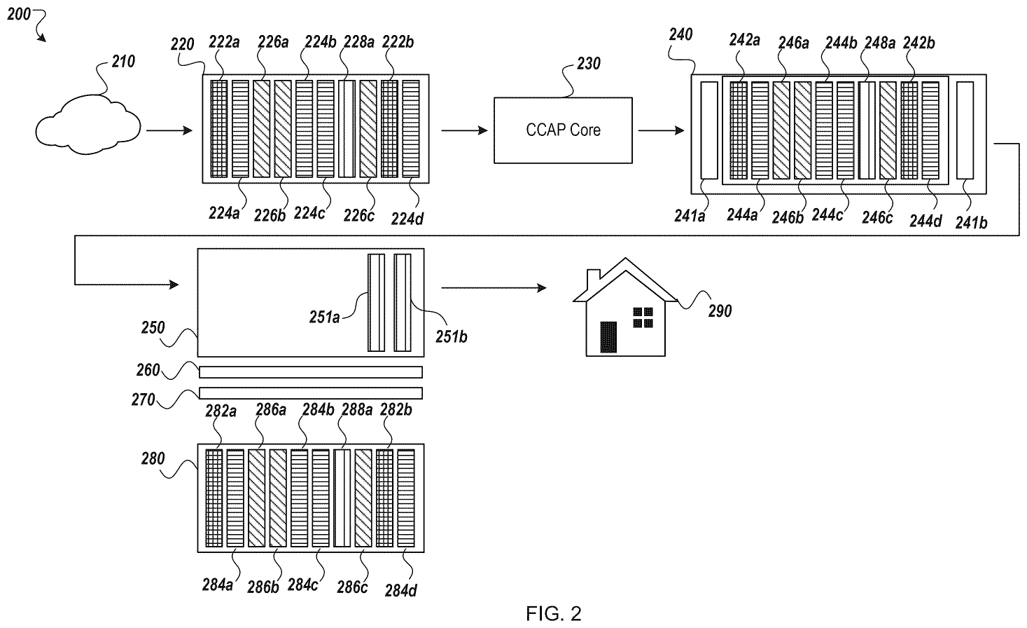

A DOCSIS data flow 200 is illustrated in FIG. 2. Internet Protocol (IP) packets 220 with priority markings may be sent from a network 210 to a CCAP core 230. The IP packets 220 with priority markings may be marked using Differentiated Services Code Point (DSCP) identifiers. For example, the IP packets 220 with priority markings may include: (i) IP packets having a DSCP=0 (e.g., IP packets 224a, 224b, 224c, 224d), (ii) IP packets having a DSCP=8 (e.g., IP packets 226a, 226b, 226c) (iii) IP packets having a DSCP=34 (e.g., IP packets 222a, 222b), and/or (iv) IP packets having a DSCP=44 (e.g., IP packets 228a). The priority markings may increase in priority as the number of the DSCP increases. For example, a DSCP=0 may have a lower priority when compared to a DSCP=8, which may have a lower priority compared to a DSCP=34, which may have a lower priority when compared to DSCP=44.

The CCAP core may receive the IP packets 220 with priority markings and generate data tunnels (e.g., service flows 240) which may be based on a quad-tuple (e.g., source IP address, source port number, destination IP address, and destination port number) which may identify a specific transmission control protocol (TCP)/user datagram protocol (UDP) connection between two devices. The service flows 240 may be shaped and queued according to traffic requests. The service flows 240 may include: (i) a lower priority of downstream traffic shaped by the CCAP core including IP packets 242a, 242b, 244a, 244b, 244c, 244d, 246a, 246b, 246c, 248a, and/or (ii) upstream MAPS having a higher priority including IP packets 241a and 241b.

At the RPD, the service flows 240 may be shaped and queued based on priority. The service flows 280 may have a low background priority and may include IP packets 282a, 282b, 284a, 284b, 284c, 284d, 286a, 286b, 286c, 288a. The service flows 250 may have a very high expedited forwarding and may include IP packets 251a, 251b. The service flows 270 may have a medium priority and the service flows 260 may have a high priority. The service flows 250, 260, 270, 280 having different priorities may be forwarded to the end user 290 via cable.

DOCSIS may use quality of service (QoS) features to manage and prioritize network traffic over cable networks so that high-priority traffic, such as video streaming and VoIP, may receive the bandwidth and low latency for optimal performance. The DOCSIS standard may provide efficient management and prioritization of network traffic, maintaining high-quality service for applications particularly sensitive to latency and bandwidth.

There may be different DOCSIS standards having different features. DOCSIS 3.1 introduced: (i) hierarchical QoS (HQoS) (e.g., an intermediate scheduling level, aggregating unicast service flows for better bandwidth management), and (ii) active queue management (AQM) (e.g., enhanced QoS by managing queue lengths and minimizing packet loss and delay through proactive queue management techniques), and (iii) orthogonal frequency-division multiplexing (OFDM) for enhanced spectrum efficiency and reduced latency (OFDM may allow for more efficient use of available bandwidth, enabling higher data rates and better performance in congested environments).

DOCSIS 4.0 introduced: (i) enhanced hierarchical QoS (EHQoS) (e.g., provides granular QoS control with aggregate service flows, supporting centralized and distributed modes for enhanced latency and bandwidth utilization), (ii) low latency services (e.g., implements proactive scheduling and dual-queue AQM to reduce packet latency across DOCSIS links), (iii) low latency xhaul (LLX) services (e.g., optimizes latency for mobile traffic on DOCSIS links with features from the low latency mobile xhaul specification), and (iv) multicast QoS (e.g., configures QoS for IP multicast sessions using group service flows with defined QoS parameters).

Thus, DOCSIS 4.0 includes symmetrical speeds, extended spectrum, proactive scheduling, and dual-queue AQM to reduce packet latency. DOCSIS 4.0 also includes low latency xhaul (LLX) services to optimize latency for mobile traffic. Symmetrical speeds and extended spectrum may facilitate higher upload speeds and better support for next-generation applications. Proactive scheduling and dual-queue AQM may reduce packet latency. Advanced queue management techniques may help maintain performance, even in congested network conditions, by proactively managing traffic and reducing delays. LLX services may optimize latency for mobile traffic on DOCSIS links. LLX services may provide better support for mobile applications so that high-priority traffic may receive the resources for optimal performance. DOCSIS 4.0 allows for enhancements in downstream and upstream performance, supporting the growing demand for high-quality internet services. Consequently, DOCSIS 4.0 provides increased network performance, supporting next-generation applications such as 8K video streaming, virtual reality (VR), and augmented reality (AR).

A summary of the different DOCSIS versions with some features and advancements is provided in Table 1.

TABLE 1
DOCSIS QoS

| DOCSIS | | | |
|---|---|---|---|
| Version | Year | QoS features | Enhancements |
| 3 | 2006 | Advanced QoS, dynamic | Channel bonding, higher data rates, |
| | | service flows | more complex service flows |
| 3.1 | 2013 | OFDM, low latency | Improved spectrum efficiency, |
| | | | reduced latency, enhanced QoS |
| | | | management |
| 4 | 2020 | Symmetrical speeds, | Higher upload speeds, better support |
| | | extended spectrum, | for next-gen applications like 8K |
| | | advanced QoS | video streaming and VR/AR |
| | | mechanisms | |

DOCSIS may have different features that may enhance QoS. Some of these features may include e.g., (i) priority queuing, (ii) service flows, (iii) traffic shaping, (iv) active queue management, and (v) EHQoS.

Priority queuing may manage traffic based on priority levels to ensure high-priority traffic may be transmitted with minimal delay. Priority queuing may be used for applications that have real-time data transmission, such as online gaming and video conferencing.

Service flows may be used to differentiate QoS for various traffic types by classifying packets into different service flows based on QoS parameters, ensuring appropriate bandwidth and latency guarantees. Service flows enable network operators to allocate resources efficiently, providing a better experience for high-priority applications.

Traffic shaping may control the traffic rate entering the network to ensure compliance with QoS policies, enhancing overall network performance. Traffic shaping may help prevent network congestion by regulating the flow of data, ensuring that high-priority traffic may not be hindered by lower-priority traffic.

AQM may enhance QoS by managing queue lengths and minimizing packet loss and delay through proactive queue management techniques. AQM techniques, such as Random Early Detection (RED) and Controlled Delay (CoDel), may help maintain network stability by reducing congestion and ensuring timely delivery of packets.

EHQoS may provide granular QoS control with aggregate service flows, supporting centralized and distributed modes for enhanced latency and bandwidth utilization. EHQoS may facilitate more precise control over network resources, allowing for better management of complex service flows and high-priority applications.

Thus, QoS in DOCSIS networks may start with basic priority queuing to ensure minimal delay for high-priority traffic. QoS in DOCSIS networks may include service flows for differentiated QoS, traffic shaping to prevent congestion, and AQM for proactive congestion management. Finally, EHQoS may provide granular control for optimal performance in complex and high-demand networks. These QoS features may allow DOCSIS networks to meet the increasing demands of modern applications and services.

The DSCP field of the cable modem's upstream packets may be marked by the demodulator/packet generator in accordance with the traffic shaping policy. Downstream per-hop behavior (PHP) and DSCP may work together to allow effective traffic management and QoS. Packets may be classified and marked with DSCP values at the headend, indicating their service level. As these marked packets travel downstream, network nodes may apply PHP based on the DSCP value, allowing packets to receive the appropriate priority and treatment.

This process may aid in traffic shaping by controlling data flow rates, minimizing congestion, and allowing high-priority traffic to be delivered efficiently. The marked packets may be then channeled to specific flow IDs, which may categorize and manage individual traffic flows, so that the marked packets may receive the appropriate resources and QoS.

Thus, high-priority traffic types like Precision Time Protocol (PTP), Bandwidth Allocation Map for Upstream Channel Descriptor (MAP), and Bandwidth Allocation Map (BWR) may be assigned higher priority to receive the requested bandwidth and low latency. Lower priority traffic, such as general internet data, may be assigned lower priority, optimizing overall network performance.

Table 2 provides an example of cable modem termination system (CMTS)/RPD priority mappings.

TABLE 2
CMTS/RPC Priority Mappings

| DSCP | Per-Hop-Behavior | Priority | Traffic Type |
|---|---|---|---|
| 0 | Best effort | Low | DOCSIS data (layer 2 tunneling |
| | | | protocol (L2TP)) |
| 46 | Expedited Forwarding | High | PTP |
| 0 | Best effort | Low | Generic Control Protocol (GCP) |
| 46 | Expedited Forwarding | High | MAP/UCD (Bandwidth allocation |
| | | | map/upstream channel descriptor) |
| 46 | Expedited Forwarding | High | BWR/RNG_REQ (Bandwidth |
| | | | Request/Range Request) |
| 32 | Class Selector 4 (CS4): | Low | Video |
| | for real-time interactive | | |
| 32 | Class Selector 4 (CS4): | Low | MDD (MAC Domain Descriptor), |
| | for real-time interactive | | Voice |

### WLAN

WLAN (e.g., Wi-Fi®) may use various techniques to prioritize specific data services within a wireless network, enhancing network performance metrics such as latency, jitter, and/or reliability, which may enhance the user experience. As Wi-Fi® technology has evolved, various QoS mechanisms have been introduced to address the growing demand for high-quality wireless connectivity.

802.11e introduced enhanced distributed channel access (EDCA) and traffic specification (TSPEC) for enhanced traffic management. The 802.11e amendment provided the foundation for subsequent enhancements.

802.11n/ac provided for enhanced throughput with features like multiple input multiple output (MIMO) and multi-user MIMO (MU-MIMO), which indirectly enhanced QoS by reducing congestion. These enhancements facilitated higher data rates and more efficient use of available spectrum, enhancing overall network performance.

802.11ax (Wi-Fi® 6) introduced orthogonal frequency-division multiple access (OFDMA), basic service set (BSS) coloring, and 1024-Quadrature Amplitude Modulation (QAM), enhancing throughput and QoS. Wi-Fi 6 provided enhanced performance in congested environments and better support for high-density deployments.

802.11be (Wi-Fi® 7) added features such as 320 megahertz (MHz) channels, 4096-QAM, and Multi-Link Operation (MLO) for further enhancements in reliability and performance. Wi-Fi® 7 provided higher data rates and lower latency, supporting the growing demand for high-quality wireless connectivity.

Table 3 shows various features such as the introduction of EDCA in 2004, the merging of 802.11e features in subsequent years, and advancements in throughput with Wi-Fi® 5 and Wi-Fi® 7, while enhancing QoS mechanisms like TSPEC, admission control, stream classification service (SCS), and mirrored SCS (MSCS).

TABLE 3
Wi-Fi ® standards supporting QoS

| | | Wi-Fi ® | | | | |
|---|---|---|---|---|---|---|
| Year | IEEE | Alliance | Comments | Features | Throughput | QoS |
| 1999 | 802.11 | Wi-Fi ® | | Distributed | | |
| | | | | Coordination | | |
| | | | | Function | | |
| | | | | (DCF), point | | |
| | | | | coordination | | |
| | | | | function (PCF) | | |
| 2004 | 802.11 | Wi-Fi ® | From | EDCA, TSpec, | | Yes |
| | | Multimedia | 802.11e | Admission Control | | |
| | | (WMM) | | | | |
| 2007 | 802.11 | WMM | Merged | EDCA, Hybrid | | Yes |
| | | | 802.11e | coordination | | |
| | | | | function (HCF) | | |
| | | | | controlled | | |
| | | | | channel access | | |
| | | | | (HCCA), TSpec, | | |
| | | | | Admission Control | | |
| 2009 | 802.11n | Wi-Fi ® 4 | | MIMO Channel | Yes | |
| | | | | Bonding Frame | | |
| | | | | Aggregation | | |
| 2012 | 802.11 | Wi-Fi ® 5 | Merged | Mesh coordination | | Yes |
| | | | 802.11n, s | function controlled | | |
| | | | | channel access | | |
| | | | | (MCCA) | | |
| | | | | Path Selection | | |
| | | | | Airtime Link | | |
| | | | | Metric Interworking | | |
| 2013 | 802.11ac | Wi-Fi ® 5 | | 160 MHz, 256- | Yes | |
| | | | | QAM, MU-MIMO), | | |
| | | | | Beamforming | | |
| 2016 | 802.11 | | Merged | SCS | | Yes |
| | | | 802.11aa, ac | | | |
| 2019 | REVmd | | | MSCS | | Yes |
| 2021 | 802.11ax | QoS | From | DSCP to user | | Yes |
| | | Management | 802.11e | priority (UP) | | |
| | | | | mapping | | |
| | | | | SCS, MSCS | | |
| 2021 | 802.11ax | Wi-Fi ® 6 | | Triggered | Yes | Yes |
| | | | | uplink access | | |
| | | | | (TUA), | | |
| | | | | OFDMA, BSS | | |
| | | | | Coloring, | | |
| | | | | Spatial Reuse, | | |
| | | | | 1024-QAM | | |
| 2022 | 802.11be | Wi-Fi ® 7 | | 320 MHz, | Yes | Yes |
| | | | | 4096-QAM, | | |
| | | | | MLO | | |

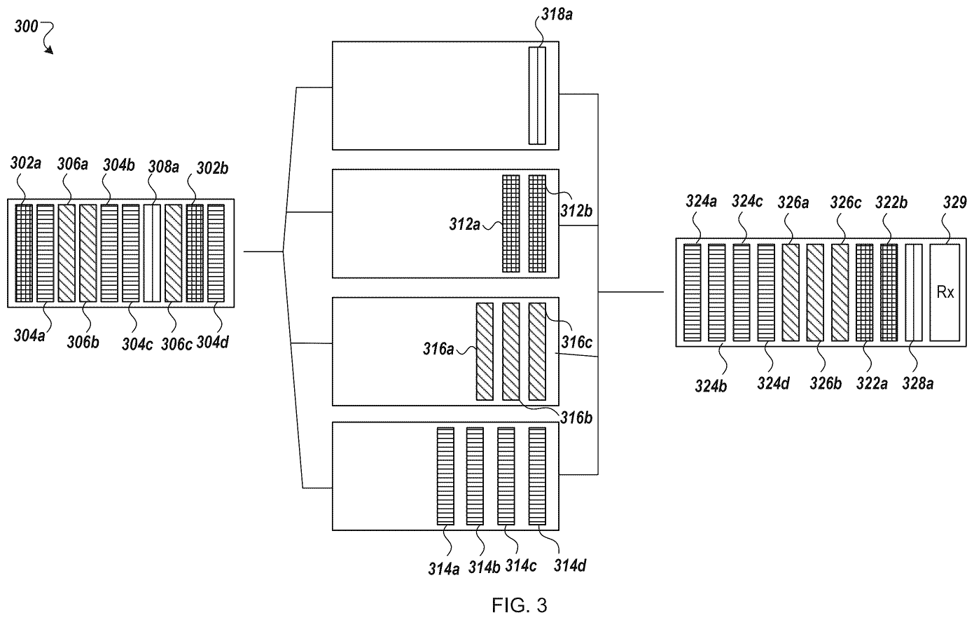

A WLAN (e.g., Wi-Fi®) data flow 300 is illustrated in FIG. 3. Downstream traffic may be carried on a cable and may include: (i) IP packets 304a, 304b, 304c, 304d having a DSCP=0, (ii) IP packets 306a, 306b, 306c having a DSCP=8, (iii) IP packets 302a, 302b having a DSCP=34, and (iv) IP packets 308a having a DSCP=44. These IP packets may be carried via a cable to a gateway which may include a Wi-Fi® access point.

At the gateway, the different IP packets may be separated into access categories. A traffic identifier (TID) of 0 (e.g., access category best effort (AC_BE) having a low priority) may include IP packets 314a, 314b, 314c, 314d which may correspond to IP packets 304a, 304b, 304c, 304d. A TID of 1 (e.g., access category background (AC_BG) having a medium priority) may include IP packets 316a, 316b, 316c, which may correspond to IP packets 306a, 306b, 306c. A TID of 4, 5 (e.g., access category video (AC_VI) having a high priority) may include IP packets 312a, 312b, which may correspond to IP packets 302a, 302b. A TID of 6, 7 (e.g., access category voice (AC_VO) having a very high priority) may include IP packet 318a, which may correspond to IP packet 308a.

From the gateway, Wi-Fi® packets may be sent to a STA. The Wi-Fi® packets may include: IP packets having a low priority (e.g., IP packets 324a, 324b, 324c, 324d); IP packets having a medium priority (e.g., IP packets 326a, 326b, 326c); IP packets having a high priority (e.g., IP packets 322a, 322b); and IP packets having a very high priority (e.g., IP packet 328a). The Wi-Fi® packets may include an Rx header 329.

Wi-Fi® may have different features that may enhance QoS. Wi-Fi QoS may use techniques to prioritize specific data services within a wireless network. This prioritization can enhance key performance indicators (KPIs) such as latency, jitter, and reliability, thereby enhancing the user experience. QoS can allow high-priority applications like voice and video to receive the bandwidth and latency for optimal performance to help maintain a reliable user experience.

One feature that Wi-Fi® may use to enhance QoS is EDCA which may divide traffic into access categories (AC) such as voice, video, best effort, and background. EDCA may manage how these data packets are prioritized and transmitted. Each category may have its own message queue and specific wireless contention parameters, including a backoff mechanism to reduce collisions, ensuring that high-priority data like voice and video get prioritized access over other types of traffic. EDCA may provide that high-priority traffic, such as voice and video, may receive preferential treatment, reducing latency and enhancing overall performance.

Traffic Specification (TSPEC) may provide for the QoS of a data flow, allowing devices to request the access point for specific QoS. TSPEC may facilitate a more efficient management of network resources so that applications receive the requested bandwidth and low latency.

SCS may allow a station to explicitly request downlink resources (uplink (UL) added in 802.11be) to the access point for meeting QoS for specific traffic flows. SCS may provide a flexible and dynamic approach to traffic management, allowing for better allocation of network resources based on current conditions.

Admission Control may be a mechanism that controls the number of high-priority data streams to prevent network overload. Admission control may provide for network stability by regulating traffic flow based on current network conditions, maintaining the QoS standards used for applications such as VOIP and video streaming.

There are numerous enhancements that occurred in Wi-Fi® 6 and Wi-Fi® 7. For example, Wi-Fi® 7 introduced several enhancements to further enhance QoS and overall network performance. These enhancements aimed to address the growing demand for high-quality wireless connectivity to support the increasing number of connected devices.

Some of the enhancements included: (i) OFDMA, (ii) 1024-QAM and 4096-QAM, (iii) MLO, (iv) trigger-based uplink access, and (v) BSS coloring.

OFDMA may allow multiple users to share a channel, boosting efficiency and reducing latency. OFDMA may facilitate a more efficient use of available spectrum, enhancing overall network performance and reducing congestion.

1024-QAM and 4096-QAM may be high-density modulation schemes that may increase data rates. These modulation techniques may facilitate higher data throughput, supporting bandwidth-intensive applications such as 4K and 8K video streaming.

Multi-link operation (MLO) may allow a station to establish multiple links in multiple bands for enhanced reliability and throughput. MLO may enhance the overall performance and reliability of Wi-Fi® networks, providing better support for high-density deployments and reducing interference.

Trigger-based uplink access (TUA) may enhance uplink performance by enabling client devices to send data upon receiving a “trigger” frame from the access point. This synchronized approach may cut down on waiting periods and contention, thus lowering latency.

BSS coloring may minimize co-channel interference by labeling frame headers, enhancing network performance. BSS coloring may help enhance the efficiency of Wi-Fi® networks, particularly in congested environments, by reducing interference and enhancing overall performance.

### DOCSIS and WLAN QoS

Combining DOCSIS and Wi-Fi QoS operations may enhance network performance and user experience. By leveraging the strengths of both technologies, network operators may provide a more seamless experience for users.

A gateway may receive data using a DOCSIS protocol and send data using a WLAN protocol. A gateway may include a processing device. The processing device may receive, at the gateway, data using a DOCSIS protocol. The data may be received using a first QoS operation. The gateway may identify, at the gateway, the first QoS operation for the DOCSIS protocol. The gateway may determine, at the gateway, a second QoS operation for a WLAN protocol. The gateway may send, from the gateway to a STA, the data using the WLAN protocol. The data may be sent using the second QoS operation.

A gateway may receive data using a WLAN protocol and send data using a DOCSIS protocol. The processing device of the gateway may receive, at the gateway, second data using the WLAN protocol. The second data may be received using a third QoS operation. The processing device may identify, at the gateway, the third QoS operation for the WLAN protocol. The processing device may determine, at the gateway, a fourth QoS operation for the DOCSIS protocol. The processing device may send, from the gateway to a server, the second data using the DOCSIS protocol. The second data may be sent using the fourth QoS operation.

The processing device may synchronize, at the gateway, a Wi-Fi transmit opportunity (TXOP) with a DOCSIS media access plan (MAP) to facilitate reduced latency. For upstream synchronization, the Wi-Fi® TXOP may be synchronized with DOCSIS upstream MAP (Media Access Plan) (e.g., which may be approximately 4 ms) to reduce latency and facilitate timely data transmission. Upstream synchronization may help maintain performance for high-priority applications, minimizing delays and enhancing overall user experience.

For downstream synchronization, the processing device may tag, at the gateway, data with a QoS parameter based on one or more of a DSCP value or an application type. The processing device may map, at the gateway, the data to a WLAN access category.

To synchronize downstream DOCSIS with WLAN (e.g., Wi-Fi®) in a gateway and reduce latency, a unified scheduling approach may be used that aligns the DOCSIS MAP timing with Wi-Fi® transmission opportunities. DOCSIS may operate on a precise scheduling model with MAP messages dictating when downstream packets are sent. When the gateway anticipates these events and coordinates them with Wi-Fi's® EDCA or scheduled QoS mechanisms like TXOP and SCS, the gateway may allow immediate Wi-Fi® transmission of arriving DOCSIS packets. Specifically, the gateway may use SCS, introduced in Institute of Electrical and Electronics Engineers (IEEE) 802.11aa and enhanced in Wi-Fi® 7 (802.11be), to tag downstream traffic flows with QoS parameters such as delay bounds and drop eligibility, based on their DSCP values or application type. These flows may be mapped to Wi-Fi® Access Categories (ACs), such as AC_VO for voice, using mechanisms like DSCP-to-UP mapping.

The DSCP values, TID values, and AC values may be mapped as shown in Table 4. The Ethernet DSCP may be contained in internet protocol version 4 (IPV4) (e.g., ToS: Type of Service) and internet protocol version 6 (IPV6) (e.g., Traffic Class). The DSCP may be 6 bits (e.g., values 0 to 63). The TID may be used at higher network layers to classify the prioritize data flows, facilitating detailed QoS management. AC values may be used at the Wi-Fi® medium access control (MAC) layer to determine contention parameters so that different traffic may be handled with appropriate priority.

TABLE 4
DSCP, TID, AC Mapping

| | WMM | | | | |
|---|---|---|---|---|---|
| DSCP | DSCP | TID | 802.11 AC | Priority | Traffic Type |
| 0 | 0 | 0 | AC_BE | Low | Best effort traffic/default |
| | | | | | for legacy traffic |
| 8 | 8 | 1 | Access category | Low | Background traffic/bulk |
| | | | background | | data transfers |
| | | | (AC_BK) | | |
| 8 | 16 | 2 | AC_BK | Low | Excellent traffic/bulk |
| | | | | | data transfers |
| 0 | 24 | 3 | AC_BE | Low | Best effort (Spare)/ |
| | | | | | default for legacy traffic |
| 34 | 32 | 4 | AC_VI | Medium | Video traffic/streaming |
| | | | | | multimedia |
| 34 | 40 | 5 | AC_VI | Medium | Video traffic/streaming |
| | | | | | multimedia |
| 44 | 48 | 6 | AC_VO | High | Voice traffic/VoIP/real- |
| | | | | | time applications |
| 44 | 56 | 7 | AC_VO | High | Voice traffic/VoIP/real- |
| | | | | | time applications |
| N/A | N/A | 8-15 | Reserved | N/A | N/A |

In a synchronized system, the gateway's central scheduler may monitor DOCSIS MAP intervals and pre-allocate Wi-Fi® TXOPs accordingly. When DOCSIS packets arrive at the gateway just before the MAP window, the scheduler may provide a corresponding TXOP on the Wi-Fi® interface, facilitating immediate forwarding without buffering. This direct flow-through path may reduce packet residence time in memory, lowering latency and DRAM utilization. Additionally, mechanisms like MSCS, also supported in 802.11be, may allow the Wi-Fi® AP to infer QoS of downlink traffic from upstream flows, enhancing automation of QoS mapping for DOCSIS traffic.

By integrating these standards-based QoS tools with DOCSIS-aware timing, the gateway may act as a hybrid coordinator that may orchestrate low-latency, low-memory transmission paths across both interfaces. This may result in a deterministic downstream path suitable for time-sensitive applications such as video conferencing, gaming, or real-time streaming-even in congested environments.

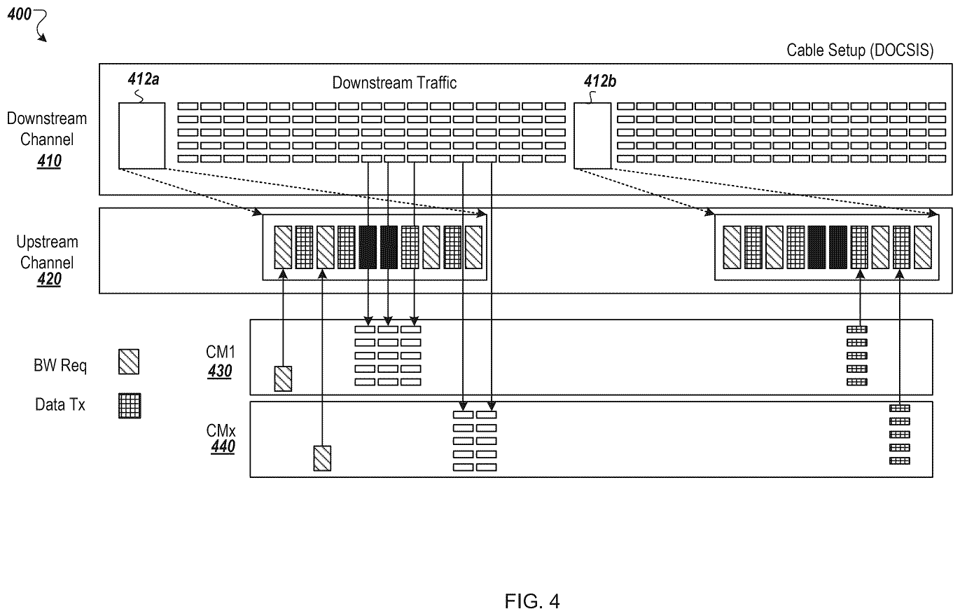

As illustrated in the DOCSIS cable setup 400 in FIG. 4, WiFi® TXOP may be synchronized with DOCSIS upstream MAP to reduce latency and facilitate timely data transmission. DOCSIS may include a downstream channel 410 and an upstream channel 420. The downstream channel 410 may include MAP packets 412a and 412b and downstream traffic. Cable modem 1 (CM1) 430 and/or Cable modem x (CMx) 440 may identify the MAP packets 412a and 412b. CM1 430 may identify a BW request from the MAP packet 412a and receive corresponding downstream traffic. CMx 440 may identify a BW request from the MAP packet 412a and receive corresponding downstream traffic. CM1 430 and CMx 440 may identify data transfer from the MAP packet 412b.

Traffic may be prioritized between the internet service provider (ISP) and the end user. The processing device may receive, at the gateway, traffic with a first priority. The processing device may send, from the gateway to the STA, the traffic with the first priority. The traffic may be sent using one or more of EDCA, TSPEC, or SCS. For DOCSIS, traffic may be prioritized from the ISP to the modem, maintaining QoS for various applications. DOCSIS may provide that high-priority traffic, such as video streaming and online gaming, receives the bandwidth and low latency for optimal performance. For Wi-Fi®, prioritization may be extended from the modem to wireless devices, facilitating prioritization. Wi-Fi® QoS operations, such as EDCA, TSPEC, and SCS, may maintain high-quality service for applications, even in congested environments.

The processing device may maintain a threshold bandwidth using the first QoS operation and the second QoS operation. DOCSIS and Wi-Fi® QoS may reduce delays and provide that high-priority data is transmitted with minimal latency. By using DOCSIS and Wi-Fi®, these technologies may provide a reliable experience for users, regardless of the type of application or network conditions.

High-priority applications like streaming and online gaming may receive steady bandwidth and low jitter so that these applications may receive the resources to maintain a high quality of service in challenging network environments. Voice over IP (VOIP) and video conferencing may benefit from reduced latency and jitter to provide clear and reliable communication. Stable and high-speed connections for streaming services and online gaming may provide a seamless user experience.

Advancements in networking protocols have been useful in addressing issues like congestion and QoS. Controlled delay (CoDel) may be an algorithm that may enhance internet connections by addressing excessive queuing delay. CoDel may be used to monitor packet time in queues and manage them to keep delays low. Technically, CoDel may track minimum queuing delay over short intervals, dropping packets if delays exceed a target value. CoDel may use a dropping strategy that may adapt to persistent congestion. This approach may signal the network to adjust data transmission, minimizing long delays and maintaining smooth data flow, even during high network usage. CoDel may enhance performance for various internet activities, potentially enhancing the responsiveness and reliability of internet connections.

A gateway may address congestion. A processing device may receive, at the gateway from the STA, a congestion detected message in which the congestion detected message may be received using a WLAN protocol. The processing device may send, from the gateway to a server, the congestion detected message in which the congestion detected message may be sent using a DOCSIS protocol. The processing device may manage, at the gateway, two or more queues for downstream traffic. The processing device may provide, at the gateway, an explicit congestion notification (ECN) bit in a packet header of a queue for downstream traffic to facilitate sending a congestion detected message to a server after receiving the congestion detected message from the STA.

Low Latency, Low Loss, Scalable throughput (LAS) may be a technology that may enhance internet connections by addressing queuing delay and packet loss. LAS may use a congestion control approach to maintain high throughput with minimal delay. Technically, LAS may use a dual-queue system with a modified ECN protocol for precise congestion signaling. LAS-compatible senders may rapidly adjust transmission rates based on these signals, keeping queue lengths short.

Unlike CoDel, which may focus on managing a queue by selectively dropping packets, LAS may use two queues: one for LAS-capable traffic and another for classic traffic. LAS may provide more frequent and precise congestion feedback to endpoints, allowing for faster response times. While CoDel aims to keep delays below a target value, LAS strives for near-zero queuing delays. This approach allows for near-zero queuing delay and minimal packet loss, even under heavy network load. LAS may enhance performance for various internet applications.

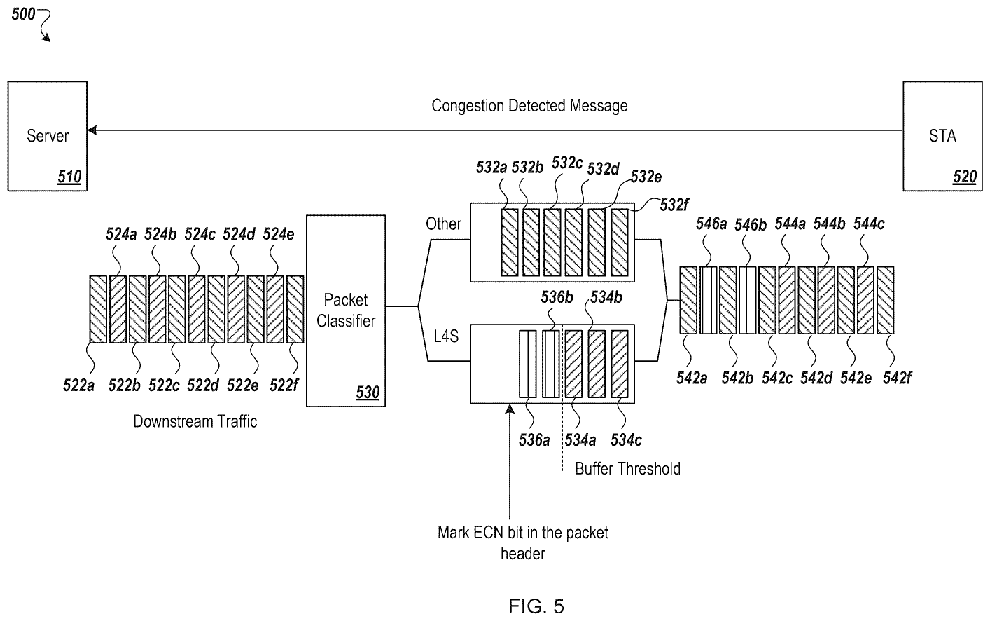

As illustrated in the diagram 500 in FIG. 5, a congestion detected message may be communicated between a STA 520 and a server 510. Downstream traffic may include a first type of traffic 522a, 522b, 522c, 522d, 522e, 522f and a second type of traffic 524a, 524b, 524c, 524d, 524e. At the gateway/router, a packet classifier 530 may classify the types of traffic so that an LAS queue receives the second type of traffic (e.g., traffic 536a, 536b, 534a, 534b, 534c) and an other queue receives the first type of traffic (e.g., traffic 532a, 532b, 532c, 532d, 532e, 532f).

The LAS queue may mark an ECN bit in the packet header. The LAS queue may have a buffer threshold that may separate the second type of traffic into a first set of traffic (e.g., traffic 536a, 536b) and a second set of traffic (e.g., 534a, 534b, 534c). The traffic from the other queue and the LAS queue may be communicated to a STA 520. The traffic (e.g., traffic 542a, 542b, 542c, 542d, 542e, 542f, 546a, 546b, 544a, 544b, 544c) may include ECN markings that were marked at the gateway/router. When the ECN markings are detected, the STA may generate a congestion detected message which may be sent to the streaming source (e.g., the server 510). The server 510 may reduce the bandwidth used when the server 510 sees the congestion detected message.

The explicit congestion notification may include 2 bits. The receiver of the marked packets may notify the sender through the TCP (Transmission Control Protocol) header (using the ECN-echo flag in the TCP header), indicating that the path is experiencing congestion. CoDel and LAS may leverage the ECN bits in the IP header to signal the onset of congestion.

Integrating DOCSIS and Wi-Fi® QoS mechanisms may create a robust framework for managing and prioritizing network traffic, enhancing overall network efficiency and user experience. As technology evolves, continuous enhancements in QoS may be used to meet the demands of modern applications and facilitate a seamless, high-quality user experience.

By leveraging the advanced features of DOCSIS 4.0 and Wi-Fi® 7, network operators may provide resources for high-priority applications, thereby delivering a reliable user experience. The collaboration between DOCSIS and Wi-Fi® QoS mechanisms may provide a comprehensive solution for managing network traffic, optimizing performance, and maintaining a high quality of service in increasingly complex and demanding network environments.

### 5G and WLAN QoS

Combining 3GPP fifth generation (5G) and WLAN (e.g., Wi-Fi®) QoS operations may enhance network performance and user experience.

The gateway may receive data receiving using a 3GPP 5G protocol and send data using a WLAN protocol. A gateway may include a processing device. The processing device may receive, at the gateway, data using a 3GPP 5G protocol. The data may be received using a first QoS operation. The processing device may identify, at the gateway, the first QoS operation for the 3GPP 5G protocol. The processing device may determine, at the gateway, a second QoS operation for a WLAN protocol. The processing device may send, from the gateway to a STA, the data using the WLAN protocol. The data may be sent using the second QoS operation.

The gateway may receive data using a WLAN protocol and send data using a 3GPP 5G protocol. The processing device may receive, at the gateway, second data using the WLAN protocol in which the second data is received using a third QoS operation. The processing device may identify, at the gateway, the third QoS operation for the WLAN protocol. The processing device may determine, at the gateway, a fourth QoS operation for the 3GPP 5G protocol. The processing device may send, from the gateway to a base station, the second data using the 3GPP 5G protocol in which the second data is sent using the fourth QoS operation.

The processing device may map, at the gateway, a QoS flow with identifier (QFI) to the second QoS operation. The processing device may synchronize, at the gateway, a Wi-Fi TXOP with a 3GPP 5G packet to facilitate reduced latency. The processing device may map, at the gateway, a 3GPP 5G QoS class to a WLAN access category.

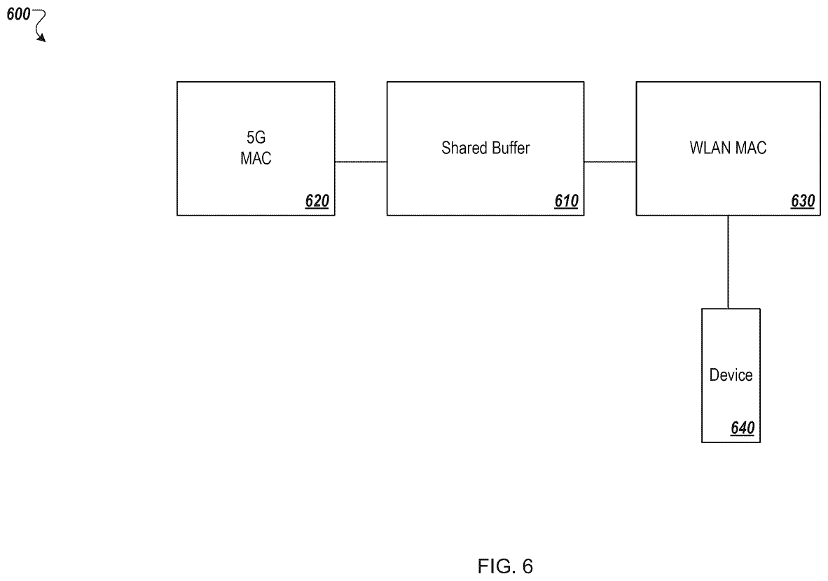

As illustrated in the block diagram 600 in FIG. 6, a 5G MAC 620 and a WLAN MAC 630 may have a shared buffer 610. The WLAN MAC may communicate with a device 640. Synchronization between 5G and Wi-Fi may be implemented in an integrated gateway product (e.g., using a shared buffer 610) to facilitate low-latency, low-memory packet forwarding. 5G networks may use QFIs that may set forth latency, jitter, and throughput standards for real-time and guaranteed-bit-rate (GBR) services. These QFIs may be mapped to Wi-Fi QoS mechanisms such as SCS and MSCS, as defined in IEEE 802.11aa and 802.11be.

In the gateway, a centralized cross-radio access technology (RAT) scheduler may observe the 5G user-plane traffic patterns and Wi-Fi® transmission opportunities, using this knowledge to align packet forwarding paths. By synchronizing the arrival of 5G packets with available Wi-Fi® TXOPs, and mapping 5G QoS classes to Wi-Fi Access Categories (e.g., AC_VO for voice), the system may avoid unnecessary buffering and facilitate immediate transmission. This may reduce latency and memory usage, achieving deterministic behavior for real-time flows. Additionally, features like Target Wake Time (TWT) and Multi-Link Operation (MLO) in Wi-Fi® 7 may be used to meet strict QoS targets originating from the 5G core. As a result, the 5G-to-Wi-Fi® gateway may facilitate low-latency handoffs of latency-sensitive applications such as voice, video conferencing, AR/VR, and cloud gaming in congested home or enterprise environments.

### PON and WLAN QoS

Combining PON and WLAN (e.g., Wi-Fi®) QoS operations may enhance network performance and user experience.

A gateway may receive data using a PON protocol and send data using a WLAN protocol. The gateway may include a processing device. The processing device may receive, at the gateway, data using a PON protocol in which the data is received using a first QoS operation. The processing device may identify, at the gateway, the first QoS operation for the PON protocol. The processing device may determine, at the gateway, a second QoS operation for a WLAN protocol. The processing device may send, from the gateway to a STA, the data using the WLAN protocol in which the data is sent using the second QoS operation.

The gateway may receive data using a WLAN protocol and send data using a PON protocol. The processing device may receive, at the gateway, second data using the WLAN protocol in which the second data is received using a third QoS operation. The processing device may identify, at the gateway, the third QoS operation for the WLAN protocol. The processing device may determine, at the gateway, a fourth QoS operation for the PON protocol. The processing device may send, from the gateway to a PON, the second data using the PON protocol in which the second data is sent using the fourth QoS operation.

The processing device may synchronize, at the gateway, a Wi-Fi TXOP with a PON frame to facilitate reduced latency. The processing device may map, at the gateway, a PON service profile to the second QoS operation. The processing device may map, at the gateway, one or more of a DSCP value or a virtual local area network (VLAN) tag to a WLAN access category.

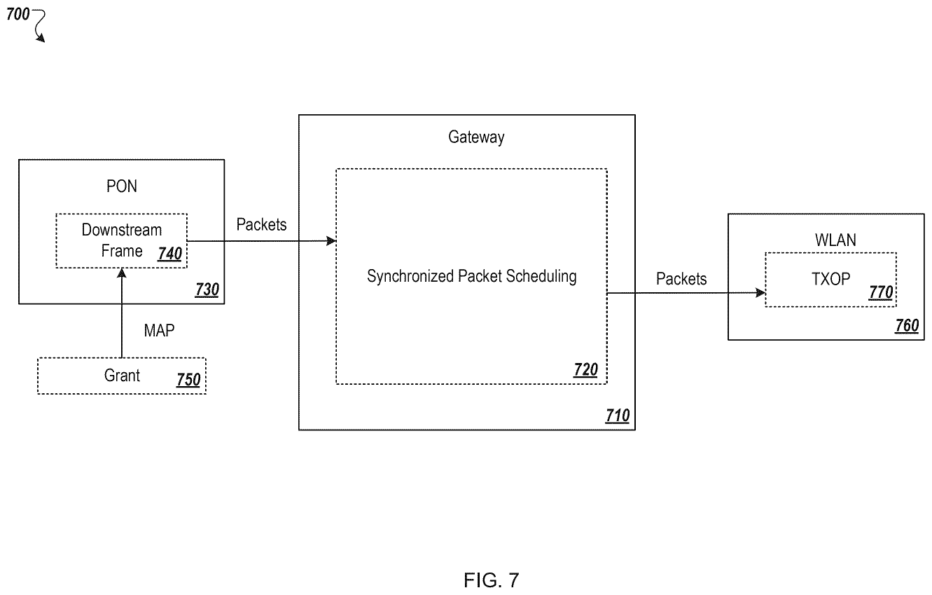

As illustrated in the block diagram 700 in FIG. 7, a gateway 710 may include a synchronized packet scheduling block 720. The gateway may receive packets (e.g., a downstream frame 740) from a PON 730 via a grant 750 using a MAP. The gateway may send the packets to a WLAN 760 via a TXOP 770.

Synchronization between PON and Wi-Fi® in a gateway 710 may enhance latency and memory efficiency. PON networks may use centralized scheduling mechanisms such as Dynamic Bandwidth Allocation (DBA) for upstream and downstream traffic, where Optical Line Terminals (OLTs) assign time slots to Optical Network Units (ONUs) or a gateway 710. By exposing the PON grant timing to the gateway's internal scheduler, the reception of downstream PON frames may be coordinated with the availability of Wi-Fi® TXOPs.

Similarly, upstream Wi-Fi® transmissions may be aligned with scheduled PON upstream slots to avoid queue buildup and delays. QoS conveyed through PON service profiles (e.g., transmission container (T-CONT) types in gigabit-capable passive optical network (GPON) or gigabit symmetrical PON (XGS-PON)) may be mapped to Wi-Fi® QoS mechanisms such as SCS or MSCS. DSCP values or VLAN tags from the PON layer may be translated to Wi-Fi® Access Categories so that time-sensitive services like voice and video may be prioritized. A central traffic manager or cross-layer scheduler within the gateway 710 may oversee this mapping and timing alignment, allowing near-instant packet bridging from PON to Wi-Fi® or vice versa without redundant buffering. This coordination may facilitate deterministic latency, reduced memory footprint, and an improved end-user experience for applications like VoIP, video streaming, and real-time collaboration over fiber-connected Wi-Fi® networks.

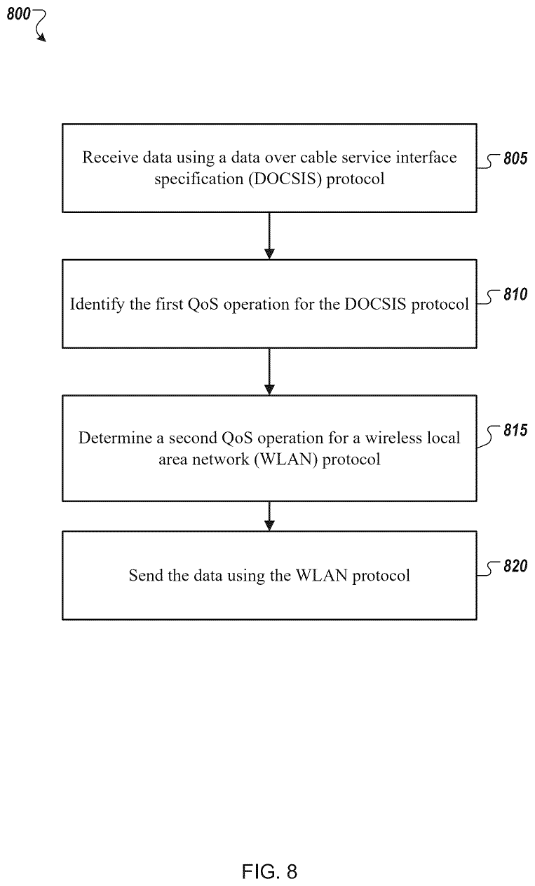

FIG. 8 illustrates a process flow of an example method 800, in accordance with at least one example described in the present disclosure. The method 800 may be arranged in accordance with at least one example described in the present disclosure.

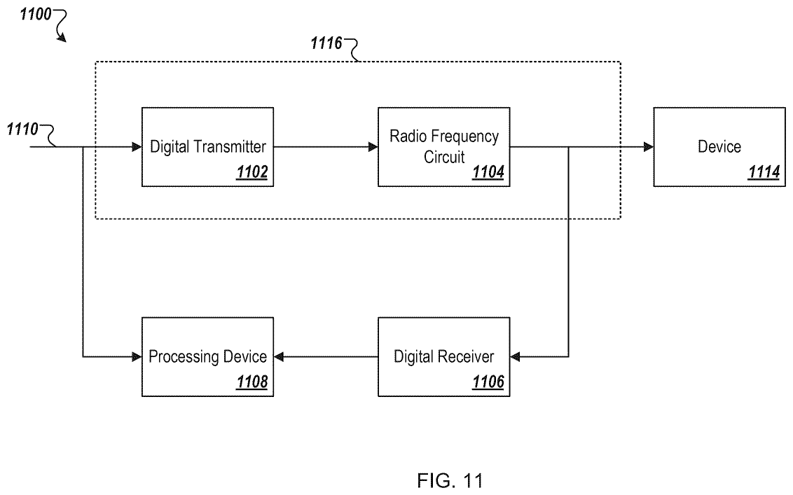

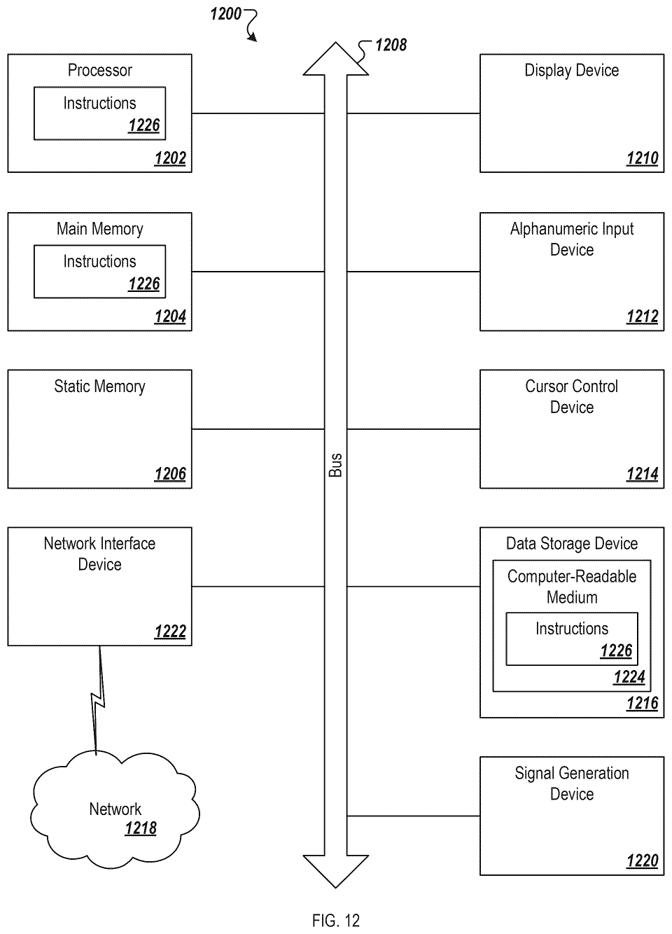

The method 800 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 1100 of FIG. 11, or another device, combination of devices, or systems.

The method 800 may begin at block 805 where the processing logic may receive, at the gateway, data using a DOCSIS protocol in which the data is received using a first QoS operation.

At block 810, the processing logic may identify, at the gateway, the first QoS operation for the DOCSIS protocol.

At block 815, the processing logic may determine, at the gateway, a second QoS operation for a WLAN protocol.

At block 820, the processing logic may send, from the gateway to a STA, the data using the WLAN protocol in which the data is sent using the second QoS operation.

Modifications, additions, or omissions may be made to the method 800 without departing from the scope of the present disclosure. For example, in some examples, the method 800 may include any number of other components that may not be explicitly illustrated or described.

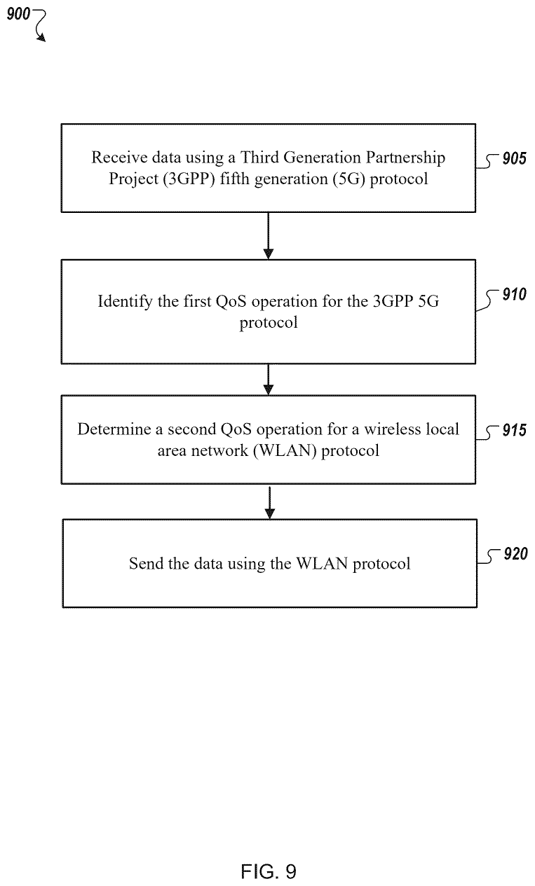

FIG. 9 illustrates a process flow of an example method 900 that may be used, in accordance with at least one example described in the present disclosure. The method 900 may be arranged in accordance with at least one example described in the present disclosure.

The method 900 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 1100 of FIG. 11, or another device, combination of devices, or systems.

The method 900 may begin at block 905 where the processing logic may receive, at the gateway, data using a 3GPP 5G protocol in which the data is received using a first QoS operation.

At block 910, the processing logic may identify, at the gateway, the first QoS operation for the 3GPP 5G protocol.

At block 915, the processing logic may determine, at the gateway, a second QoS operation for a WLAN protocol.

At block 920, the processing logic may send, from the gateway to a STA, the data using the WLAN protocol in which the data is sent using the second QoS operation.

Modifications, additions, or omissions may be made to the method 900 without departing from the scope of the present disclosure. For example, in some examples, the method 900 may include any number of other components that may not be explicitly illustrated or described.

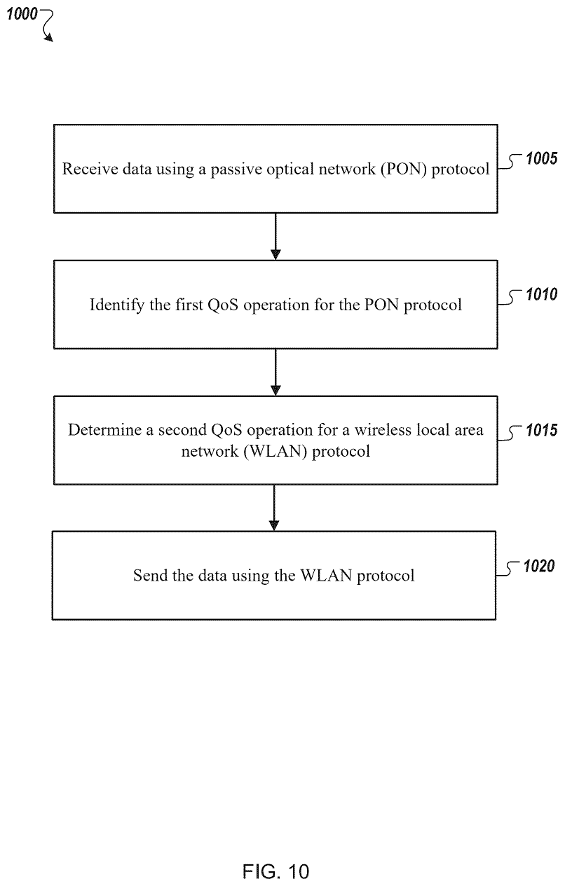

FIG. 10 illustrates a process flow of an example method 1000 that may be used, in accordance with at least one example described in the present disclosure. The method 1000 may be arranged in accordance with at least one example described in the present disclosure.

The method 1000 may be performed by processing logic that may include hardware (circuitry, dedicated logic, etc.), software (such as is run on a computer system or a dedicated machine), or a combination of both, which processing logic may be included in the processing device 1202 of FIG. 12, the communication system 1100 of FIG. 11, or another device, combination of devices, or systems.

The method 1000 may begin at block 1005 where the processing logic may receive, at the gateway, data using a PON protocol in which the data is received using a first QoS operation.

At block 1010, the processing logic may identify, at the gateway, the first QoS operation for the PON protocol.

At block 1015, the processing logic may determine, at the gateway, a second QoS operation for a WLAN protocol.

At block 1020, the processing logic may send, from the gateway to a STA, the data using the WLAN protocol in which the data is sent using the second QoS operation.

Modifications, additions, or omissions may be made to the method 1000 without departing from the scope of the present disclosure. For example, in some examples, the method 1000 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 11 illustrates a block diagram of an example communication system 1100, in accordance with at least one example described in the present disclosure. The communication system 1100 may include a digital transmitter 1102, a radio frequency circuit 1104, a device 1114, a digital receiver 1106, and a processing device 1108. The digital transmitter 1102 and the processing device may receive a baseband signal via connection 1110. A transceiver 1116 may include the digital transmitter 1102 and the radio frequency circuit 1104.

In some examples, the communication system 1100 may include a system of devices that may communicate with one another via a wired or wireline connection. For example, a wired connection in the communication system 1100 may include one or more Ethernet cables, one or more fiber-optic cables, and/or other similar wired communication mediums. Alternatively, or additionally, the communication system 1100 may include a system of devices that may communicate via one or more wireless connections. For example, the communication system 1100 may include one or more devices that may transmit and/or receive radio waves, microwaves, ultrasonic waves, optical waves, electromagnetic induction, and/or similar wireless communications. Alternatively, or additionally, the communication system 1100 may include combinations of wireless and/or wired connections. In these and other examples, the communication system 1100 may include one or more devices that may obtain a baseband signal, perform one or more operations to the baseband signal to generate a modified baseband signal, and transmit the modified baseband signal, such as to one or more loads.

In some examples, the communication system 1100 may include one or more communication channels that may communicatively couple systems and/or devices included in the communication system 1100. For example, the transceiver 1116 may be communicatively coupled to the device 1114.

In some examples, the transceiver 1116 may obtain a baseband signal. For example, as described herein, the transceiver 1116 may generate a baseband signal and/or receive a baseband signal from another device. In some examples, the transceiver 1116 may transmit the baseband signal. For example, upon obtaining the baseband signal, the transceiver 1116 may transmit the baseband signal to a separate device, such as the device 1114. Alternatively, or additionally, the transceiver 1116 may modify, condition, and/or transform the baseband signal in advance of transmitting the baseband signal. For example, the transceiver 1116 may include a quadrature up-converter and/or a digital to analog converter (DAC) that may modify the baseband signal. Alternatively, or additionally, the transceiver 1116 may include a direct radio frequency (RF) sampling converter that may modify the baseband signal.

In some examples, the digital transmitter 1102 may obtain a baseband signal via connection 1110. In some examples, the digital transmitter 1102 may up-convert the baseband signal. For example, the digital transmitter 1102 may include a quadrature up-converter to apply to the baseband signal. In some examples, the digital transmitter 1102 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 1102.

In some examples, the transceiver 1116 may include one or more subcomponents that may be used in preparing the baseband signal and/or transmitting the baseband signal. For example, the transceiver 1116 may include an RF front end (e.g., in a wireless environment) which may include a power amplifier (PA), a digital transmitter (e.g., 1102), a digital front end, an IEEE 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1104) of the transceiver 1116 may be synchronized with the resource controller via the S-plane device, which may contribute to high-accuracy timing with respect to a reference clock.

In some examples, the transceiver 1116 may obtain the baseband signal for transmission. For example, the transceiver 1116 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1116 may generate a baseband signal for transmission. In these and other examples, the transceiver 1116 may transmit the baseband signal to another device, such as the device 1114.

In some examples, the device 1114 may receive a transmission from the transceiver 1116. For example, the transceiver 1116 may transmit a baseband signal to the device 1114.

In some examples, the radio frequency circuit 1104 may transmit the digital signal received from the digital transmitter 1102. In some examples, the radio frequency circuit 1104 may transmit the digital signal to the device 1114 and/or the digital receiver 1106. In some examples, the digital receiver 1106 may receive a digital signal from the RF circuit and/or send a digital signal to the processing device 1108.

In some examples, the processing device 1108 may be a standalone device or system, as illustrated. Alternatively, or additionally, the processing device 1108 may be a component of another device and/or system. For example, in some examples, the processing device 1108 may be included in the transceiver 1116. In instances in which the processing device 1108 is a standalone device or system, the processing device 1108 may communicate with additional devices and/or systems remote from the processing device 1108, such as the transceiver 1116 and/or the device 1114. For example, the processing device 1108 may send and/or receive transmissions from the transceiver 1116 and/or the device 1114. In some examples, the processing device 1108 may be combined with other elements of the communication system 1100.

FIG. 12 illustrates a diagrammatic representation of a machine in the example form of a computing device 1200 within which a set of instructions, for causing the machine to perform any one or more of the methods discussed herein, may be executed. The computing device 1200 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1200 includes a processing device (e.g., a processor 1202), a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one example, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1224 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A gateway, comprising:
a processing device operable to:
receive, at the gateway, data using a data over cable service interface specification (DOCSIS) protocol, wherein the data is received using a first quality of service (QoS) operation;
identify, at the gateway, the first QoS operation for the DOCSIS protocol;
determine, at the gateway, a second QoS operation for a wireless local area network (WLAN) protocol; and
send, from the gateway to a station (STA), the data using the WLAN protocol, wherein the data is sent using the second QoS operation.

2. The gateway of claim 1, wherein the processing device is further operable to:
synchronize, at the gateway, a Wi-Fi transmit opportunity (TXOP) with a DOCSIS media access plan (MAP) to facilitate reduced latency.

3. The gateway of claim 2, wherein the processing device is further operable to:
tag, at the gateway, the data with a QoS parameter based on one or more of a differentiated services code point (DSCP) value or an application type.

4. The gateway of claim 3, wherein the processing device is further operable to:
map, at the gateway, the data to a WLAN access category.

5. The gateway of claim 1, wherein the processing device is further operable to:
receive, at the gateway, traffic with a first priority; and
send, from the gateway to the STA, the traffic with the first priority, wherein the traffic is sent using one or more of enhanced distributed channel access (EDCA), traffic specification (TSPEC), or stream classification service (SCS).

6. The gateway of claim 1, wherein the processing device is further operable to:
maintain a threshold bandwidth using the first QoS operation and the second QoS operation.

7. The gateway of claim 1, wherein the processing device is further operable to:
receive, at the gateway from the STA, a congestion detected message, wherein the congestion detected message is received using a WLAN protocol; and
send, from the gateway to a server, the congestion detected message, wherein the congestion detected message is sent using a DOCSIS protocol.

8. The gateway of claim 1, wherein the processing device is further operable to:
manage, at the gateway, two or more queues for downstream traffic.

9. The gateway of claim 1, wherein the processing device is further operable to:
provide, at the gateway, an explicit congestion notification (ECN) bit in a packet header of a queue for downstream traffic to facilitate sending a congestion detected message to a server after receiving the congestion detected message from the STA.

10. The gateway of claim 1, wherein the processing device is further operable to:
receive, at the gateway, second data using the WLAN protocol, wherein the second data is received using a third QoS operation;
identify, at the gateway, the third QoS operation for the WLAN protocol;
determine, at the gateway, a fourth QoS operation for the DOCSIS protocol; and
send, from the gateway to a server, the second data using the DOCSIS protocol, wherein the second data is sent using the fourth QoS operation.

11. A gateway, comprising:
a processing device operable to:
receive, at the gateway, data using a Third Generation Partnership Project (3GPP) fifth generation (5G) protocol, wherein the data is received using a first quality of service (QoS) operation;
identify, at the gateway, the first QoS operation for the 3GPP 5G protocol;
determine, at the gateway, a second QoS operation for a wireless local area network (WLAN) protocol; and
send, from the gateway to a station (STA), the data using the WLAN protocol, wherein the data is sent using the second QoS operation.

12. The gateway of claim 11, wherein the processing device is further operable to:
map, at the gateway, a QoS flow with identifier (QFI) to the second Qos operation.

13. The gateway of claim 11, wherein the processing device is further operable to:
synchronize, at the gateway, a Wi-Fi transmit opportunity (TXOP) with a 3GPP 5G packet to facilitate reduced latency.

14. The gateway of claim 11, wherein the processing device is further operable to:
map, at the gateway, a 3GPP 5G QoS class to a WLAN access category.

15. The gateway of claim 11, wherein the processing device is further operable to:
receive, at the gateway, second data using the WLAN protocol, wherein the second data is received using a third QoS operation;
identify, at the gateway, the third QoS operation for the WLAN protocol;
determine, at the gateway, a fourth QoS operation for the 3GPP 5G protocol; and
send, from the gateway to a base station, the second data using the 3GPP 5G protocol, wherein the second data is sent using the fourth QoS operation.

16. A gateway, comprising:
a processing device operable to:
receive, at the gateway, data using a passive optical network (PON) protocol, wherein the data is received using a first quality of service (QoS) operation;
identify, at the gateway, the first QoS operation for the PON protocol;
determine, at the gateway, a second QoS operation for a wireless local area network (WLAN) protocol; and
send, from the gateway to a station (STA), the data using the WLAN protocol, wherein the data is sent using the second QoS operation.

17. The gateway of claim 16, wherein the processing device is further operable to:
synchronize, at the gateway, a Wi-Fi transmit opportunity (TXOP) with a PON frame to facilitate reduced latency.

18. The gateway of claim 16, wherein the processing device is further operable to:
map, at the gateway, a PON service profile to the second QoS operation.

19. The gateway of claim 16, wherein the processing device is further operable to:
map, at the gateway, one or more of a differentiated services code point (DSCP) value or a virtual local area network (VLAN) tag to a WLAN access category.

20. The gateway of claim 16, wherein the processing device is further operable to:
receive, at the gateway, second data using the WLAN protocol, wherein the second data is received using a third QoS operation;
identify, at the gateway, the third QoS operation for the WLAN protocol;
determine, at the gateway, a fourth QoS operation for the PON protocol; and
send, from the gateway to a PON, the second data using the PON protocol, wherein the second data is sent using the fourth QoS operation.
